(19) United States
(12) Patent Application Publication
(10) Pub. No.: US 2026/0354361 A1
(43) Pub. Date: Nov. 12, 2026

(54) Swim Bait

(71) Applicant: Joseph Lord, Parker, CO (US)

(72) Inventor: Joseph Lord, Parker, CO (US)

(21) Appl. No.: 19/666,935

(22) Filed: May 4, 2026

Related U.S. Application Data
(60) Provisional application No. 63/800,907, filed on May 6, 2025.

(51) Int. Cl. A01K 85/00; A01K 85/01

(52) U.S. Cl. CPC A01K 85/1807; A01K 85/011; A01K 85/018; A01K 85/1811

(57) ABSTRACT

An example swim bait configured to mimic the natural movement of a fish includes a body made of plastisol or a soft plastic material. The body has flexibility to enable lifelike swimming motion that allows the swim bait to bend and wiggle fluidly, replicating the movements of a real baitfish. A scoop-shaped nose is located at a front portion of the body and is angled to capture and channel water during retrieval or trolling. The flow of water against the scoop-shaped nose generates side-to-side motion and imparts a realistic wiggling action along the body and a tail portion of the swim bait. A tail portion may be sculpted to include tapering and curvature that amplify natural fluttering and kicking movement underwater.

### PRIORITY CLAIM

This application claims the priority filing benefit of U.S. Provisional Patent Application No. 63/800,907 filed May 6, 2025 for “Swim Bait” of Joseph Lord, hereby incorporated by reference in its entirety as though fully set forth herein.

### BACKGROUND

Swim baits are fishing lures designed to mimic the natural movement of fish for attracting predatory species such as bass. Those crafted from hard plastic or wood are particularly popular due to their durability and realistic swimming action. Hard plastic swim baits are lightweight and versatile, while wooden swim baits offer natural buoyancy and a unique motion in the water. Available in floating, sinking, and slow-sinking configurations, these swim baits are popular for targeting larger, cautious fish such as pike, muskie, largemouth bass, and salmon and other saltwater species (e.g., tarpon, marlin, etc.).

Detailed paint, three-dimensional (3D) eyes, and textured scales can further enhance realism of the swim baits, increasing their effectiveness in both freshwater and saltwater environments. While swim baits often feature realistic appearances, their movement can sometimes fall short of mimicking the natural behavior of live bait. This discrepancy poses challenges for anglers, especially when targeting larger, more cautious fish such as bass, pike, or muskie. Predatory fish rely on their keen senses to identify prey, and any unnatural swimming motion can raise suspicion, causing these fish to avoid striking the lure.

In addition, experienced anglers often face heightened difficulty in heavily fished waters, where fish have learned to associate unnatural movement with danger or traps. This reduces the effectiveness of swim baits that fail to replicate lifelike motion. The issue becomes particularly evident when dealing with finicky fish during periods of low activity when even slight deviations in movement are more noticeable.

Many swim baits feature multi-jointed or segmented designs that are intended to replicate lifelike swimming patterns. But these also often fall short. As a result, anglers often try to compensate by employing advanced techniques, such as adjusting retrieve speed or incorporating rod movements, to try and simulate a more convincing action. This added complexity can detract from the enjoyment of the fishing experience, making realistic motion a critical factor in the design and use of effective swim baits.

### BRIEF DESCRIPTION OF THE DRAWINGS

FIG. 1 shows a bottom perspective view of an example swimbait with a hook provided on a dropper chain, and a separate rigging stop or retaining plug that may be inserted in a through hole in the swimbait for connecting the fishing line.

FIG. 2 is a top perspective view of the swimbait without the hook.

FIG. 3 is another bottom perspective view of the swimbait corresponding to FIG. 2.

FIG. 4 is a side view of the swimbait corresponding to FIG. 2.

FIG. 5 shows a mold that can be used to manufacture the swimbait.

FIG. 6 shows another example of a rigging stop or retaining plug.

FIG. 7 is a top, front perspective view of another design of the swimbait having an angled front or head portion.

### DETAILED DESCRIPTION

A swim bait (or lure) is disclosed herein that addresses the shortcomings of hard plastic and wooden swim baits, by achieving lifelike movement. Unlike traditional lures, the swim bait disclosed herein is molded from a flexible material that allows it to wiggle and move with a natural fluidity, mimicking the swimming motion of live baitfish.

In an example, a swim bait is disclosed as it is configured to mimic the natural movement of a fish. The swim bait includes a flexible body made of a soft plastic material. The flexible body is flexible to enable a lifelike swimming motion that allows the swim bait to bend and wiggle fluidly to substantially replicate the movements of a live baitfish. An angled front or head portion is located at an anterior segment of the flexible body. The angled front or head portion is configured to capture and channel water during retrieval or trolling, wherein the flow of water against the angled front or head portion generates side-to-side motion and imparts a wiggling action along the flexible body. A tail portion extends from the flexible body. The tail portion is sculpted to include tapering and curvature configured to amplify fluttering and kicking movement underwater. An interior passage is formed at least partially through the flexible body. A through-line rigging system is disposed within the interior passage for routing a fishing line.

In another example, a swim bait is configured to mimic the natural movement of an aquatic creature. The swim bait includes a flexible body molded from a soft plastic material. An angled head portion is located at an anterior segment of the flexible body. The angled head portion defines an exposed surface for capturing water resistance. The angled head portion is configured with an angle ranging from about 20 degrees to 85 degrees to manipulate a specific swimming movement of the flexible body at different retrieval speeds. A through-line rigging system is disposed within the flexible body for routing a fishing line.

In another example, a swim bait is configured to maintain structural integrity and stability during casting and trolling. The swim bait includes a flexible body molded from a soft plastic material, the flexible body having an anterior segment and a belly side. An angled head portion is located at the anterior segment, the angled head portion defining an exposed surface for capturing water resistance. An interior passage extends entirely through the flexible body from the angled head portion to the belly side. A through-line plastic tube is inserted into the interior passage for routing a fishing line. In an example, the plastic tube has a substantially T-shape for insertion into the interior passage on the belly side. The plastic tube is configured to catch against the flexible body at a side of resistance, thereby preventing the plastic tube from sliding out of the flexible body when pulled toward the angled head portion during casting or trolling. In an example, a hook assembly is provided having a weight exiting a center of the belly side of the flexible body. The weight may be configured to keep the swim bait upright and stable during retrieval.

The soft plastic construction not only enhances its realism but also increases its appeal to fish, reducing the chances of spooking fish in clear or heavily fished waters. Whether retrieved at varying speeds or fished in challenging conditions, this swim bait maintains its natural action, giving anglers the edge needed to outsmart even the most discerning game fish.

The plastisol or other soft plastic swim bait is both realistic in appearance and adaptable for use in different environments and with different fish species. Its flexible construction provides a fluid, natural swimming motion, so that it mimics live baitfish. This lifelike action is particularly advantageous in clear water or heavily fished areas, where fish tend to be more cautious and less likely to be fooled by traditional lures. Anglers can use this swim bait with versatile retrieval techniques, such as slow, steady pulls for subtle movement or fast, erratic retrieves to imitate distressed baitfish. Additionally, the lure accommodates precision depth control through weights or rigging, making it suitable for targeting species like bass, muskie, and walleye, and salmon and other saltwater species (e.g., tarpon, marlin, etc.).

The soft plastic material is durable enough to withstand multiple strikes while remaining pliable for realistic movement. The ability to incorporate pigments into the mold allows customization to match local forage species, increasing its appeal to regional fish. Moreover, the mold can integrate recessed hooks, reducing the risk of snagging while maintaining optimal strike efficiency. By enhancing an angler's ability to mimic live baitfish and offering greater flexibility in presentation.

Before continuing, it is noted that as used herein, the terms “includes” and “including” mean, but is not limited to, “includes” or “including” and “includes at least” or “including at least.” The term “based on” means “based on” and “based at least in part on.”

The term “swim bait” as used herein refers to, but is not limited to, a type of fishing lure designed to imitate the appearance and movement of live baitfish to attract predatory fish.

The term “plastisol” as used herein refers to, but is not limited to, a suspension of polyvinyl chloride (PVC) particles in a liquid plasticizer, which becomes a solid but flexible material when heated and cooled, commonly used in making fishing lures.

The term “forage species” as used herein refers to, but is not limited to, types of fish or other aquatic animals that predatory fish typically feed on.

The term “jig head” as used herein refers to, but is not limited to, a type of fishing hook with a lead weight molded onto the shank, used to give a lure weight and a specific action in the water.

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

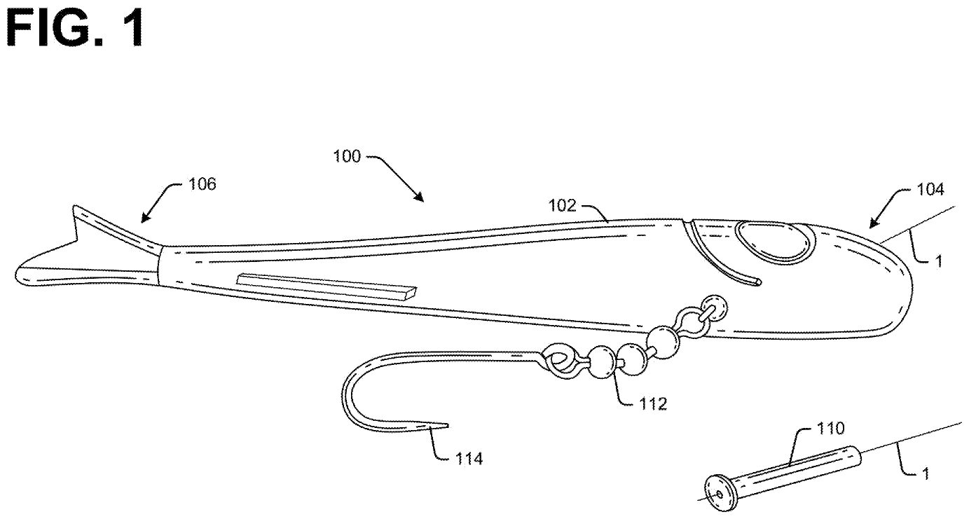

FIG. 1 shows a bottom perspective view of an example swimbait 100. The swim bait 100 includes a tail portion 106 positioned on the left side of the illustration and an angled front or head portion 104 located on the right side. In an example, the head portion has a contoured configuration which forms a substantially spoon shaped scoop 105. The swim bait 100 includes a flexible body 102 molded from a plastisol or other soft material (e.g., soft plastic), which provides the dynamic flexibility necessary for a lifelike swimming motion that allows the lure to bend and wiggle fluidly during use.

It is noted that the term “plastisol” is used herein to refer to a type of soft plastic that is suitable for making the swim bait disclosed herein. However, the swim bait disclosed herein is not limited to manufacture of plastisol. Other examples of materials are also contemplated as being within the scope of the disclosure, as will be readily understood by those having ordinary skill in the art after becoming familiar with the teachings herein. The scope of the claims is not intended to be limited to these examples.

It is noted that other materials can also be utilized, especially when considering different properties and desired outcomes. By way of nonlimiting example, silicone is a suitable alternative that offers flexibility and durability. It's often preferred for its resistance to tearing and its ability to maintain shape even after numerous fish strikes. Silicone can also be easily colored and scented. Thermoplastic Elastomers (TPEs) are a class of materials that combine the properties of rubber and plastic, and provide good flexibility and durability, similar to silicone, and may even be more environmentally friendly than plastisol. Various other types of soft plastics can be used, though the specific properties may vary.

Each of these materials has advantages and disadvantages in terms of flexibility, durability, ease of molding, cost, and environmental impact. Still other materials can be utilized that remain flexible and can be molded into the desired shape and withstand repeated use. The choice of material may also depend at least to some extent on the specific requirements of the lure design and the angler's preferences.

In an example, the angled front or head portion 104 has a scoop-shaped nose designed to capture and channel water during retrieval or trolling. The flow of water against this exposed surface generates a lateral displacement that imparts a continuous side-to-side wiggling action along the flexible body 102 and the tail portion 106.

In an example, the angle of the head portion 104 can range from about 20 degrees to about 85 degrees to manipulate the swimming movement at different speeds. For example, a shallow angle between about 20 and about 30 degrees helps the swim bait 100 dive and remain stable during high-speed trolling, an angle of about 45 degrees maintains neutral buoyancy and facilitates wiggling at slow speeds, and steeper angles between about 60 and about 85 degrees amplify the side-to-side wiggling to mimic a swimming leech. The tail portion 106 can also be sculpted, e.g., with tapering and curvature to further amplify natural fluttering and kicking movements underwater.

FIG. 1 further illustrates components of a through-line rigging system that routes a fishing line 1 through an interior passage 108 formed at least partially through the flexible body 102. A rigging stop or retaining plug 110 is configured to be removably inserted into the interior passage 108 to securely retain the fishing line 1 therein. In one embodiment, this rigging stop or retaining plug 110 is configured as a plastic tube with a T-shape which when inserted retains the plug 110 on the belly side of the flexible body 102. This T-shape acts to catch against the side of resistance, securely preventing the plastic tube from sliding out of the flexible body 102 when pulled toward the angled head portion 104 during casting or trolling.

It is noted that the swim bait may have more than one interior chambers formed therein and/or one or more of the interior passages may be formed fully or at least partially through the flexible body 102. In an example, the chamber(s) and/or passages provide a through-line rigging system for fishing line, weight, and/or one or more hooks. This configuration helps ensure that the swim bait can be securely rigged for casting from shore or trolling from a boat, maintaining proper alignment and action in either scenario.

In an example, the through-line rigging system for fishing line, weight, and/or one or more hooks is molded into the swim bait during manufacture so that the swim bait can be securely rigged for casting, maintaining proper alignment and action.

Extending from internal passage 108 at the bottom of the flexible body 102 is a dropper chain 112 (also referred to as a chain connector), which connects to a hook 114. To ensure the swim bait 100 remains upright and stable during retrieval, the hook assembly can also incorporate a weight exiting the center of the belly.

It should be understood that the components and configurations described in relation to FIG. 1 are provided for purposes of illustration and are not intended to be limiting. For instance, as used herein, the terms “includes” and “comprising” mean “including at least,” and other devices or device configurations may be utilized to carry out the described operations without departing from the scope of the present disclosure. Furthermore, the flexible body 102 can be customized with various pigments, glitter, 3D eyes, textured scales, or scents to match local forage species and enhance visual and olfactory attraction.

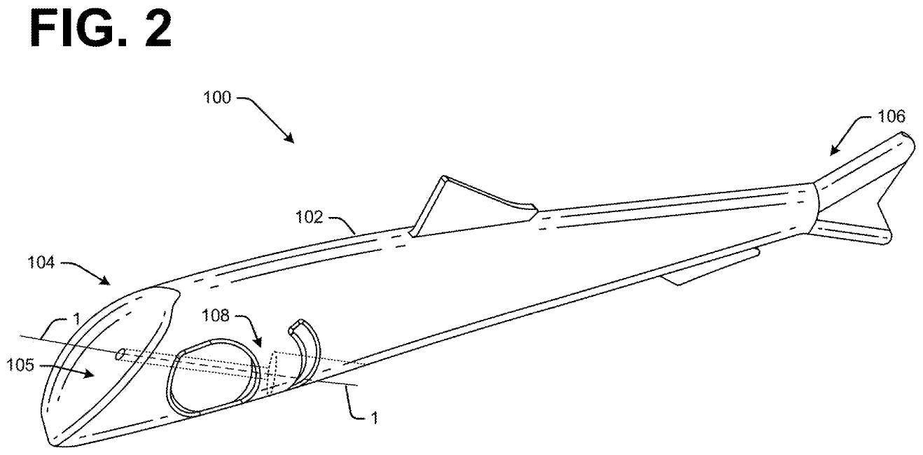

Referring now to FIG. 2, a top perspective view of the swim bait 100 is shown with the angled front or head portion 104 facing to the left of the image, depicted without the hook 114 attached. From this dorsal perspective, the streamlined profile of the flexible body 102 is visible, which minimizes unnatural drag and provides the dynamic flexibility necessary to replicate the fluid, lifelike swimming motion of a real baitfish. To match local forage species and adapt to various fishing conditions, the flexible body 102 may be customized. For example, the flexible body 102 may be multi-layered or treated with various pigments, glitter, or scent, and may incorporate highly realistic details such as textured scales or 3D eyes to enhance the visual and olfactory attraction for predatory fish.

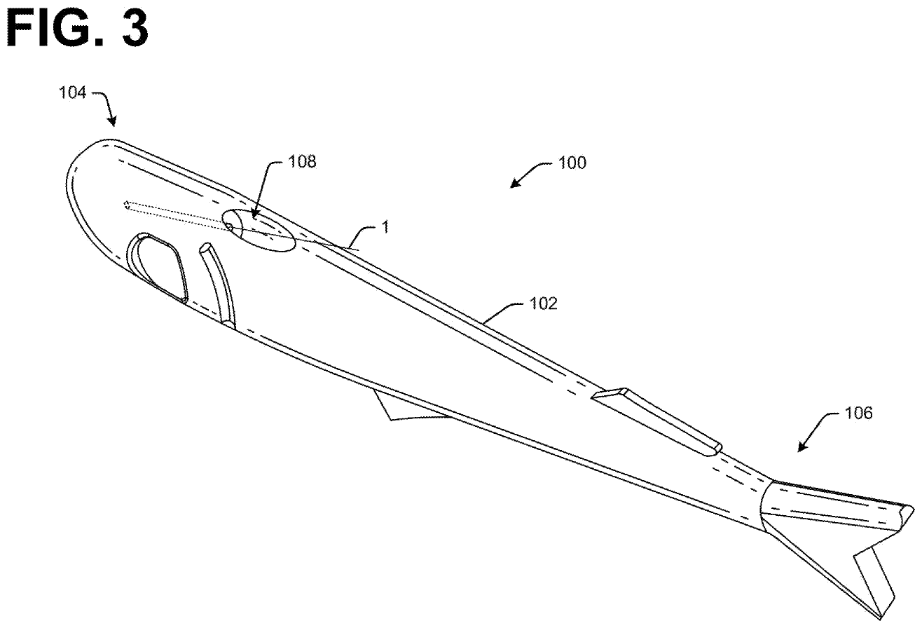

FIG. 3 illustrates a bottom perspective view of the swim bait 100, corresponding to the configuration shown in FIG. 2. This view shows the belly side of the flexible body 102, where the interior passage 108 exits the material. As part of the through-line rigging system, a rigging stop or retaining plug 110 (such as a plastic tube with an opening therethrough for the fishing line) is routed through the interior passage 108. To ensure the rigging stop or retaining plug 110 remains secure, it may have a T-shape or other suitable mechanism that is configured to catch against the flexible body 102 on the belly side at the side of resistance. This T-shape physically prevents the tube from sliding out of the flexible body 102 when the fishing line is pulled toward the angled front or head portion 104 during casting or trolling. Furthermore, this central belly area provides an exit point for a hook assembly weight. Positioning the weight at the center of the belly ensures the swim bait 100 remains upright and hydrodynamically stable during retrieval.

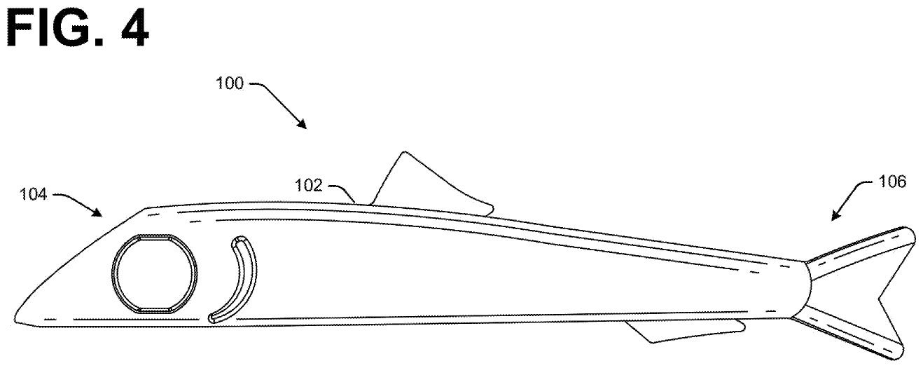

FIG. 4 depicts a side profile view of the swim bait 100, further illustrating the geometric relationship between the angled front or head portion 104, the flexible body 102, and the tail portion 106. As shown in this profile, the angled front or head portion 104 features a scoop-shaped nose configured to capture and channel water resistance. The specific angle of this exposed surface can be selected from a broad range of about 20 degrees to about 85 degrees to manipulate the hydrodynamic wiggling response at different speeds.

In an example, an angle between about 40 and about 60 degrees (such as about a 45-degree angle) allows the swim bait 100 to maintain neutral buoyancy and imparts a realistic side-to-side wiggling action at slow speeds. Conversely, a shallower angle of about 20 to about 30 degrees causes the swim bait 100 to dive and remain stable at faster trolling speeds, while a steeper angle between about 60 and about 85 degrees amplifies the lateral displacement to accurately mimic the swimming motion of a leech. Moving posteriorly, the side view also shows the tail portion 106, which is sculpted with tapering and curvature to amplify the natural fluttering and kicking movements as water flows past the flexible body 102.

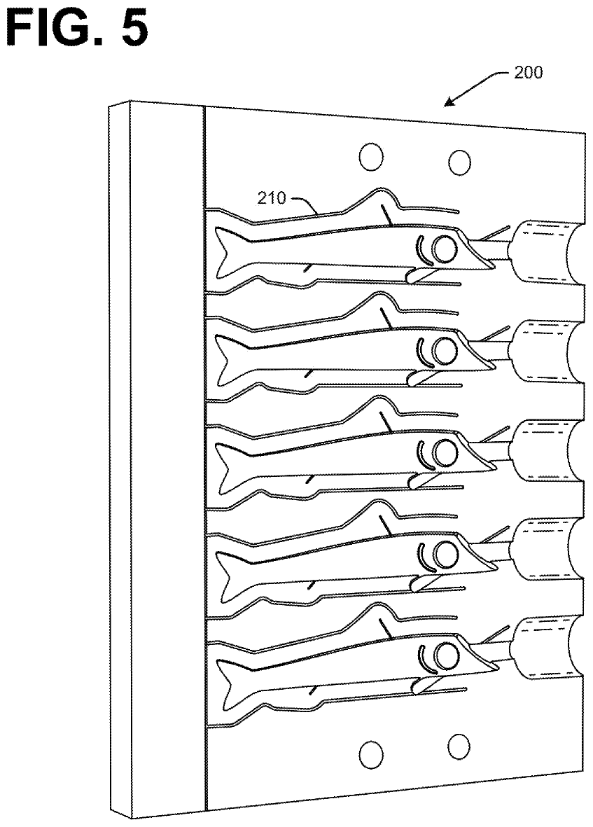

FIG. 5 shows a mold 200 that can be used to manufacture the swimbait. As shown, the mold 200 includes multiple forms or interior cavities 210 configured to shape and produce multiple swim baits 100 simultaneously without limiting the production capacity to any specific number. In an example, the injection mold 200 may be crafted from metal, silicone, or other suitable tooling materials. The interior cavities 210 are contoured to provide the realistic features of a baitfish and can even integrate intricate structural details such as scale patterns, fins. Recessed areas are formed to accommodate hooks, weights, and the interior passage 108 for the through-line rigging system.

During an example manufacturing process, a liquid polymer material, such as plastisol, is prepared and heated to a pourable consistency. Prior to molding, various additives such as pigments, glitter, or scent may be incorporated into the liquid material to customize the appearance and olfactory appeal of the final product, allowing the swim bait 100 to be tailored to match local forage species. The liquid material is then poured or injected into the interior cavities 210 of the mold 200. To manufacture multi-colored swim baits, additional layers of material may be poured sequentially into the injection mold 200 to create varied visual or transparency effects.

Once filled, the mold 200 is cooled, allowing the material to solidify into the flexible body 102. Cooling chambers may be utilized to expedite this curing process and ensure consistency across manufacturing batches. After solidification, the swim baits 100 are demolded and may undergo trimming and finishing steps to remove excess material or rough edges. Final finishing touches, such as painting, adding 3D eyes, or assembling the dropper chain 112, hooks 114, and the rigging stop or retaining plug 110, can also be completed at this post-molding stage to provide the user with a fully functional device.

An example manufacturing process for producing the soft plastic/plastisol swim baits disclosed herein produces high-quality, lifelike lures with attention to detail. It begins with the preparation of the plastisol, a liquid plastic material that becomes solid yet flexible when heated. Additives like pigments, glitter, or scent can be incorporated at this stage to customize the appearance and appeal of the swim bait. This step ensures the material is tailored to the specific needs of anglers and regional fishing conditions.

Next, the mold configuration shapes the lure. Molds can be crafted from metal or silicone, featuring details such as scale patterns, fins, and recessed areas for hooks, weights and/or other accessories. The molds are configured to capture the realistic features of baitfish, contributing to the lifelike appearance of the swim bait. After the plastisol is prepared, it is heated to a temperature resulting in a pourable consistency. The liquid plastisol is then carefully poured into the molds, ensuring all cavities are completely filled. For multi-colored swim baits, additional layers of plastisol may be poured sequentially to create the desired effect.

After filling, the molds are left to cool, allowing the plastisol to solidify into its final form. In an example, cooling chambers can expedite this process while ensuring consistency across batches. After the swim bait has hardened, it is removed from the mold in a step known as demolding. Care is taken during this process to preserve the intricate details and ensure the lure is free of defects.

Following demolding, the swim bait undergoes trimming and finishing. Excess material or rough edges can be removed to create a polished appearance. Additional finishing touches, such as painting and/or the addition of 3D eyes or other features, may be applied to enhance the visual appeal of the swim bait. Hooks and/or other components can also be assembled at this stage. In an example, recessed hooks can be provided directly into the mold. In another example, the hooks can be added manually as part of the manufacturing process, or by the end-user. The resulting swim bait provides anglers with a realistic, customizable, and reliable fishing tool.

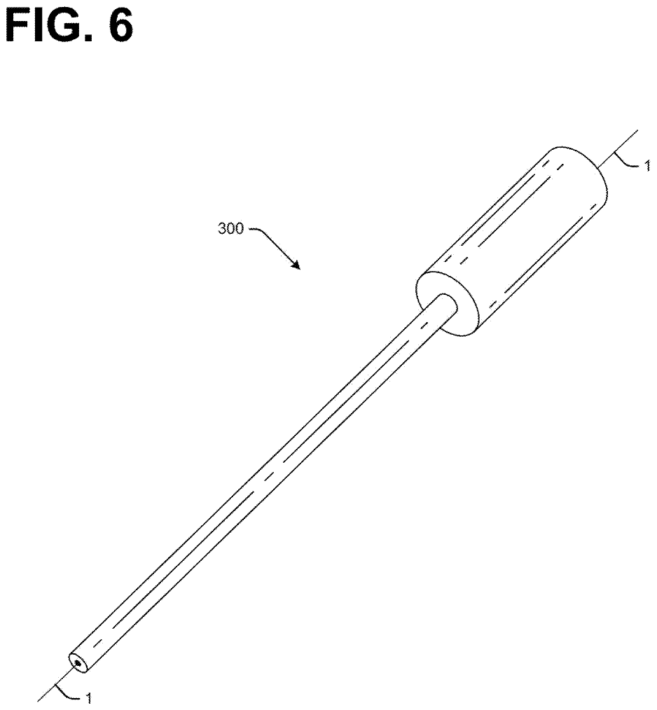

FIG. 6 is an isolated view of the rigging stop or retaining plug 300 such as the one described above with reference to FIG. 1. As previously described, the rigging stop or retaining plug 30 is a component of the through-line rigging system and is configured to be inserted into the interior passage of the swim bait for connecting to the fishing line 1.

In the illustrated embodiment, the rigging stop or retaining plug 300 is a plastic tube having a retention shape such as but not limited to a substantially T-shape on the end that corresponds to the belly side of the flexible body. This T-shape catches the body of the swim bait at the side of resistance. During casting or trolling, the pulling force of the fishing line is entirely directed toward the head of the lure. Without this T-shape catching against the flexible material, the tube would slide out of the swim bait, preventing the device from performing as designed.

By securely routing and retaining the line through the body, the rigging stop or retaining plug 300 maximizes the hydrodynamic utility of the angled front or head portion. This internal rigging ensures the entire head remains optimally exposed to the resistance of the water, which forces the swim bait to wiggle and swim realistically rather than rolling or pulling unnaturally.

While the rigging stop or retaining plug 110 is described herein as a plastic tube having a T-shape, it should be understood that this is provided for purposes of illustration and is not intended to be limiting. Various alternative materials, such as durable metals or composite blends, and alternative retention geometries, such as flanged ends, ribbed outer textures, or friction-fit taperings, may be utilized to securely retain the fishing line within the interior passage without departing from the broader scope of the present disclosure.

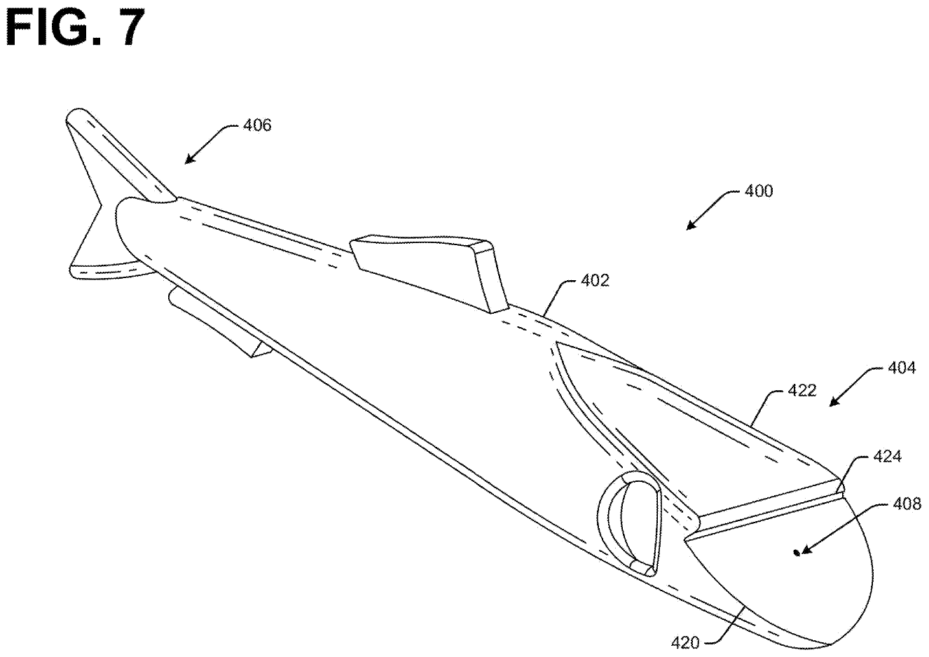

FIG. 7 is a top/front perspective view of another design of the swimbait 400 having an angled front or head portion. It is noted that 400-series reference numbers are used to refer to similar components referenced as 100-series in FIG. 1. These components may not be described again with reference to FIG. 7.

In the example shown in FIG. 7, the swim bait 400 includes a flexible body 402 and is characterized by a uniquely profiled angled front or head portion 404. As previously discussed, the specific pitch or angle of this exposed surface is customizable to manipulate how much the swim bait wiggles and responds to water resistance at different retrieval speeds.

For example, the front or head portion 404 may include multiple angled surfaces, such as rearward sloping angled surfaces 420, 422 separated by a forward sloping angled surface 424 between the rearward sloping angled surfaces. Each of these surfaces 420, 422, 424 may be configured with the same or different angles to reduce frontal water resistance, helping the swim bait 400 to penetrate the water, dive deeper, and maintain upright stability during high-speed trolling applications. Other angles can be utilized to maximize water capture, which amplifies the side-to-side wiggling action to effectively mimic the erratic swimming movements of different aquatic creatures, such as a leech.

Similar to previous embodiments, the swim bait 400 incorporates the internal through-line rigging system 408 to ensure the fishing line is securely routed through an interior passage of the flexible body 402. This system can also utilize the previously described rigging stop or retaining plug to prevent the line from pulling through the body during casting or trolling. By securing the line internally, the entire surface area of the angled front or head portion 404 remains fully exposed to the resistance of the water, forcing the flexible body 402 to swim realistically.

It should be recognized that the specific features, geometries, and angles shown in FIG. 7 are intended as illustrative examples rather than strict limitations. The flexible body 402 may be manufactured from a wide variety of suitable soft plastic materials, including but not limited to plastisol, silicone, or thermoplastic elastomers (TPEs). Furthermore, the swim bait 400 may be highly customized with multi-layered color presentations, pigments, glitter, scent, and specific buoyancy profiles (e.g., floating, sinking, or neutrally buoyant) to match local forage species and adapt to dynamic fishing conditions. As used throughout this description, the terms “includes” and “comprising” are meant to be open-ended, meaning “including at least,” and other configurations or combinations of these described features may be utilized without departing from the broader scope of the present disclosure.

As described above, the various configurations of swim bait mimic the natural movement of a fish, due to unique physical characteristics and material composition. The body is made from plastisol or other soft plastic that provides the flexibility for lifelike swimming motion. This material allows the bait to bend and wiggle fluidly, replicating the movements of a real baitfish. The swim bait also has a scoop-shaped nose at the front or head portion. Different angles can be used for different presentations. For example, steeper angles cause wiggling side-to-side instead of diving. When changing the pitch the swim bait tends to dive better. The scoop-shaped nose captures and channels water during retrieval or trolling. The flow of water against the scoop nose generates side-to-side motion and imparts a realistic wiggling action along the body and tail, closely imitating the behavior of live prey. In an example, the tail is also sculpted to enhance realism, incorporating features such as tapering and curvature that amplify its natural fluttering and kicking movement underwater.

The anterior segment incorporates a scoop-shaped nose which hydrodynamically channels water flow during retrieval or trolling. This design induces lateral displacement and generates a periodic wiggling motion propagating along the body to the caudal extremity, emulating the behavioral patterns of live prey.

The sculpted tail, with tapered and curved elements, enhances its natural fluttering and kicking movement. In an example, a through-line rigging system provides alignment for casting from shore or trolling from a boat. It is customizable in color and buoyancy. The swim bait can be tailored to float, sink, or remain neutrally buoyant, as well as match local forage species or specific fishing conditions, making it a versatile and realistic option for anglers.

In an example, the swim bait is customizable, with the ability to be produced in any color to match local forage species and/or specific fishing conditions. It can also be tailored for different buoyancy profiles, allowing it to float, sink, or remain neutrally buoyant, depending on the desired fishing application. A through-line rigging system for fishing line, weight (e.g., in the mouth of the swim bait), and/or one or more hooks can be molded into the swim bait so that the swim bait can be securely rigged for casting, maintaining proper alignment and action. Adaptations permit the lure to float, sink, or achieve neutral buoyancy while precisely replicating local forage species or catering to distinct environmental and fishing parameters. This level of technical refinement positions the swim bait as an advanced solution for realistic aquatic simulation.

An example fishing technique using the swim bait is by using a slow and controlled retrieve, often referred to as “slow rolling.” This approach takes full advantage of the lifelike wiggling action of the swim bait, allowing it to closely mimic the movement of a natural baitfish.

The swim bait is selected that matches the forage fish commonly found in the target fishing area, both in size and color. The swim bait is rigged on a weighted jig head or a belly-weighted hook, ensuring the weight allows the bait to reach and maintain the desired depth. The swim bait can be cast, and sinks to the appropriate depth. The retrieve starts at a steady, moderate speed, using the reel to control the movement. The goal is to keep the swim bait swimming just above the bottom or at the depth where fish are actively feeding. Occasionally the user may pause or vary the speed slightly to imitate the erratic movements of a distressed or injured fish, which can provoke strikes from hesitant predators.

For added effectiveness, the user can impart subtle twitches or lifts with the rod during the retrieve, enhancing the natural swimming action of the swim bait. This technique works especially well in clear or lightly stained water, where the realistic motion and appearance of the swim bait is most visible to fish. Slow rolling the swim bait can produce consistent results and draw in even the most cautious of predators.

During the slow rolling technique, the swim bait displays an incredibly lifelike appearance as it glides through the water. Its soft, flexible construction allows for natural movement that closely resembles a live baitfish. With each turn of the reel, the swim bait wiggles gently, creating fluid side-to-side motions in its body and tail. These movements give the impression of a fish swimming steadily at a controlled pace.

The configuration of the swim bait, including but not limited to textured scales, realistic fins, and/or vibrant pigments, enhances its visual appeal underwater. If equipped with 3D eyes and subtle glitter, the lure reflects light, adding an extra dimension of realism and catching the attention of nearby fish. Even minor pauses or variations in retrieve speed make the swim bait appear distressed or injured, amplifying its effectiveness.

As it swims, the swim bait maintains a stable trajectory due to the rigging and weight balance, but remains flexible enough to respond to rod twitches or subtle adjustments. This dynamic behavior mirrors the unpredictable movement of actual baitfish, making the swim bait irresistible to predatory fish observing it from their hiding spots.

It is noted that the examples shown and described are provided for purposes of illustration and are not intended to be limiting. Still other examples are also contemplated.

1. A swim bait configured to mimic the natural movement of a fish, comprising:
a flexible body made of a soft plastic material, the flexible body having flexibility to enable lifelike swimming motion that allows the swim bait to bend and wiggle fluidly to replicate the movements of a live baitfish;
an angled front or head portion located at an anterior segment of the flexible body, the angled front or head portion configured to capture and channel water during retrieval or trolling, wherein the flow of water against the angled front or head portion generates side-to-side motion and imparts a wiggling action along the flexible body;
a tail portion extending from the flexible body, the tail portion sculpted to include tapering and curvature configured to amplify fluttering and kicking movement underwater;
an interior passage formed at least partially through the flexible body; and
a through-line rigging system disposed within the interior passage for routing a fishing line.

2. The swim bait of claim 1, further comprising:
a rigging stop removably insertable into the interior passage with the fishing line passing therethrough; and
a hook connected to the flexible body via a dropper chain extending from the fishing line passing through the rigging stop and exiting a bottom of the flexible body.

3. The swim bait of claim 1, wherein the angled front or head portion is angled at about 45 degrees to maintain neutral buoyancy and facilitate a side-to-side wiggling action at slow speeds.

4. The swim bait of claim 1, wherein the angled front or head portion is angled between about 20 degrees and 30 degrees to cause the swim bait to dive and remain stable at faster trolling speeds.

5. The swim bait of claim 1, wherein the angled front or head portion is angled between about 40 degrees and 60 degrees to manipulate an amount of wiggling motion during retrieval.

6. The swim bait of claim 1, wherein the angled front or head portion is angled between about 60 degrees and 85 degrees to amplify side-to-side wiggling motion to imitate a swimming leech.

7. The swim bait of claim 2, wherein the rigging stop or retaining plug comprises a plastic tube configured to be routed through the angled front or head portion and out a belly side of the flexible body.

8. The swim bait of claim 7, wherein the rigging stop or retaining plug includes a T-shape on the belly side configured to catch at a side of resistance and prevent the plastic tube from sliding out of the flexible body during casting or trolling.

9. The swim bait of claim 2, wherein the hook includes a weight exiting a center of the bottom of the flexible body, wherein the weight is configured to keep the swim bait upright and stable.

10. The swim bait of claim 1, further comprising recessed hook channels integrated into the flexible body for reduced snagging and optimized strike efficiency.

11. The swim bait of claim 1, wherein the soft plastic material is plastisol, silicone, or a thermoplastic elastomer (TPE).

12. The swim bait of claim 1, wherein the flexible body comprises one or more of textured scales, 3D eyes, pigments, glitter, or scent to enhance visual and olfactory attraction.

13. The swim bait of claim 1, wherein the flexible body is multi-layered to provide a combination of colors or transparency effects.

14. The swim bait of claim 1, wherein the flexible body is configured with a selected buoyancy profile to float, sink, or remain neutrally buoyant based on a desired fishing application.

15. The swim bait of claim 1, wherein the tail portion further comprises a soft, flexible fin element to enhance the fluttering and kicking movement.

16. The swim bait of claim 1, wherein the hook is a weighted jig head or a belly-weighted hook configured to allow the swim bait to maintain a target depth during a slow-rolling retrieval.

17. A swim bait configured to mimic the natural movement of an aquatic creature, comprising:
a flexible body molded from a soft plastic material;
an angled head portion located at an anterior segment of the flexible body, the angled head portion defining an exposed surface for capturing water resistance, wherein the angled head portion has at least one angled surface; and
a through-line rigging system disposed within the flexible body for routing a fishing line.

18. The swim bait of claim 17, further comprising first and second angled surfaces each having an angle between about 20 degrees and about 30 degrees, wherein the angle configures the swim bait to dive and remain stable during higher speed trolling.

19. The swim bait of claim 17, further comprising first and second angled surfaces each having an angle between about 60 degrees and about 85 degrees, wherein the angle configures the swim bait to amplify side-to-side wiggling motion to mimic a swimming leech.

20. A swim bait configured to maintain structural integrity and stability during casting and trolling, comprising:
a flexible body molded from a soft plastic material, the flexible body having an anterior segment and a belly side;
an angled head portion located at the anterior segment, the angled head portion defining at least one exposed contoured surface for capturing water resistance;
an interior passage extending entirely through the flexible body from the angled head portion to the belly side;
a through-line tube inserted into the interior passage for routing a fishing line, wherein the plastic tube has a generally T-shape on the belly side configured to catch against the flexible body at a side of resistance, thereby preventing the plastic tube from sliding out of the flexible body when pulled toward the angled head portion during casting or trolling; and
a hook assembly having a weight exiting a center of the belly side of the flexible body, wherein the weight is configured to keep the swim bait upright and stable during retrieval.
